(19) United States
(12) Patent Application Publication
(10) Pub. No.: US 2018/0113794 A1
(43) Pub. Date: Apr. 26, 2018

(54) WEBGL APPLICATION ANALYZER

(71) Applicant: Intel Corporation, Santa Clara, CA (US)

(72) Inventors: Jin Yang, Shanghai (CN); Junchao Han, Shanghai (CN); Zidong Jiang, Shanghai (CN); Yongnian Le, Shanghai (CN)

(21) Appl. No.: 15/569,331

(22) PCT Filed: Jun. 10, 2015
(86) PCT No.: PCT/CN2015/081148

§ 371 Date: Oct. 25, 2017

(51) Int. Cl. G06F 11/36; G06F 9/54

(52) U.S. Cl. CPC G06F 11/3668; G06F 9/54; G06F 8/447

(57) ABSTRACT

Various systems and methods for analyzing WebGL applications are described herein. A system comprises a recorder service module to intercept a plurality of graphics application programming interface (API) function calls, each of the plurality of graphics API functions calls having an associated execution context; a command translator module to translate the plurality of graphics API functions calls to a set of generic API invocations; a code generator module to generate executable code from the set of generic API invocations; and a replayer service module to test the executable code.

### TECHNICAL FIELD

Embodiments described herein generally relate to software performance profiling and in particular, to a system for analyzing WebGL applications.

### BACKGROUND

HTML5 is a markup language that builds on the technologies provided in HTML 4.01 and XHTML 1.1. WebGL (Web Graphics Library) is a JavaScript application programming interface (API) for rendering computer graphics within a web browser without the use of a plug-in. WebGL is an integrated technology in HTML5. Through the use of HTML5's canvas object and scripts that use the WebGL API, developers are able to provide rich two-dimensional (2D) and three-dimensional (3D) graphics.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a flowchart illustrating control and data flow during operation, according to an embodiment;

FIG. 2 is a block diagram illustrating a system for analyzing WebGL applications, according to an embodiment;

FIG. 3 is a flowchart illustrating a method of analyzing WebGL applications, according to an embodiment; and

FIG. 4 is a block diagram illustrating an example machine upon which any one or more of the techniques (e.g., methodologies) discussed herein may perform, according to an example embodiment.

### DETAILED DESCRIPTION

Systems and methods described herein provide mechanisms for analyzing WebGL applications. A WebGL application runs in a web browser.

With the WebGL JavaScript API, developers are able to create fantastic 3D games or applications. Because of the popularity and the inherent advantage of HTML5 (e.g., write once, run within many browsers), more developers are producing 3D games with either the WebGL API directly or with various WebGL-based game engines.

When a WebGL-based 3D application is not performing well, it is difficult to identify the source of the problem. Because each browser may implement its own platform to handle WebGL commands, it may be difficult to determine whether a particular 3D application is limited by hardware (e.g., graphics processing unit (GPU)) or software (e.g., some WebGL implementation problem inside the browser).

To date, there are no existing tools for testing or optimizing WebGL programs. While some browsers provide programmers with tracing tools (e.g., Google Chrome™ browser), such tools do not provide detailed insight into the WebGL program's operation independent of the browser's environment. Thus, for example, a tracing tool may indicate that a WebGL program is GPU bound, but may not be able to indicate whether the same WebGL program run on another browser would also be GPU bound. Browser implementations may change frequently, further complicating analysis. To perform proper analysis, the graphics commands initiated by WebGL calls should be separately analyzed from graphics commands issued by the browser. Thus, there is a need to analyze a WebGL program independent from the underlying browser platform.

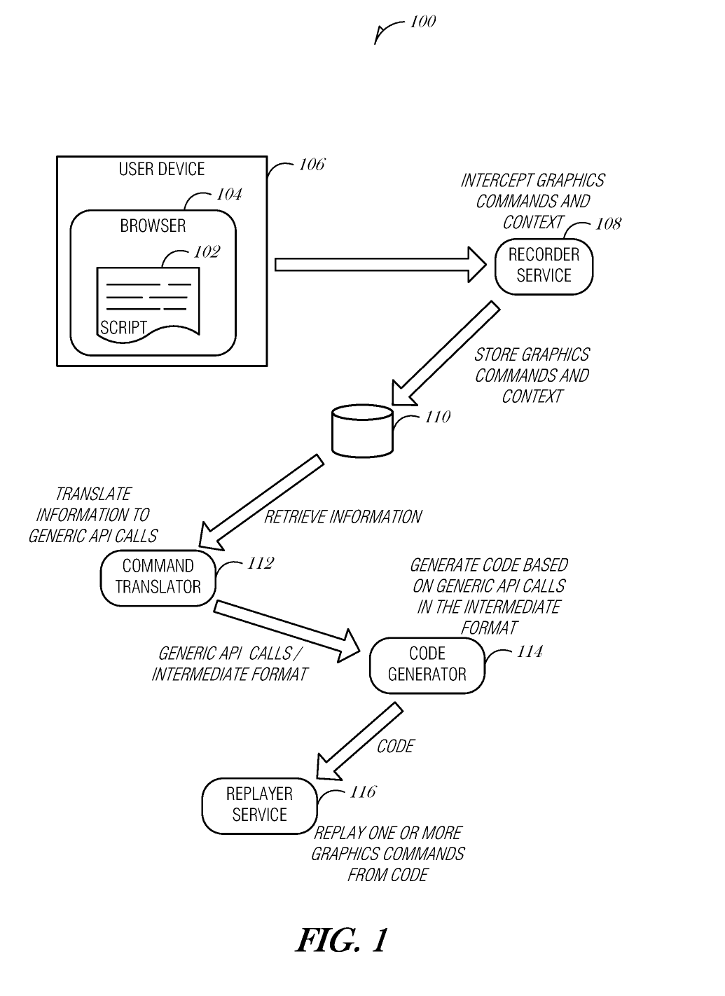

FIG. 1 is a flowchart illustrating control and data flow during operation, according to an embodiment. A script 102 is executed within a browser 104 on a user device 106. The script 102 may be considered a WebGL program if it invokes at least one WebGL function from a WebGL API. WebGL programs includes control code, which may be written in JavaScript or another scripting language, and shader code that is executed on a GPU. While JavaScript is presently used for WebGL, it is understood that any client-side scripting language may be adapted to use a WebGL API. For example, a VBScript library may be developed to provide a WebGL API to VBScript client-side scripts.

The script 102 executes within the browser 104. The browser 104 may be any web browser application capable of executing client-side scripts and presenting visual images. Examples of browsers include, but are not limited to Mozilla Firefox®, Google Chrome™, Apple Safari®, and Microsoft Internet Explorer®. The browser 104 executes on a user device 106. The user device 106 may be any type of compute device including, but not limited to an onboard vehicle system, set-top box, wearable device, personal computer (PC), a tablet PC, a hybrid tablet, a personal digital assistant (PDA), a mobile telephone, or the like.

A user may or may not interact with the script 102 via the browser 104. In either case, a recorder service 108 is used to monitor and record graphics commands issued by the script 102. The recorder service 108 may exist in various layers of the software stack, for example, in the scripting engine (e.g., JavaScript engine), in the browser as a native function or an extension, or as a standalone application. In an example, the recorder service 108 is implemented as a JavaScript module and is injected into the HTML page before the WebGL script 102 is executed.

The recorder service 108 records the graphics commands issued by the script 102, saving them to a data store 110. The recorder service 108 may buffer a number of API calls before dumping them to the data store 110. The recorder service 108 records the graphics commands and the associated context of the API call. The context of the API call may include object properties and attributes at the time of the call, parameter values, values of global variables, values of local variables, or information on the function call stack or execution stack.

A command translator 112 parses the information stored in the data store 110 by the recorder service 108 and translates the graphics commands to a set of generic API invocations. The generic API invocations are in an intermediate format, which is not specific to any programming language. In an example, the script 102 is a WebGL script that invokes a WebGL API, where the commands are captured and recorded by the recorder service 108 and later translated to an OpenGL command. The OpenGL command may be any of OpenGL command implementations, such as OpenGL ES 2.0.

By performing the translation, native OpenGL commands may be mapped to WebGL commands line by line so that developers may isolate and analyze browser implementations of graphics commands quickly and easily. For example, developers may utilize tools that already exist for analyzing OpenGL application to conduct functionality debugging and performance analysis with the translated applications. Such analysis may provide insight into browser limitations or other implementation bottlenecks, which may impact the WebGL-based application.

Thus, after the command translator 112 parses the information in the data store 110 to output generic API invocations, a code generator 114 is used to interpret the intermediate format of generic API invocations and generate corresponding native OpenGL code. The code may be in a certain language for a certain OpenGL platform. For example, the code generator 114 may generate Android Java SDK-based OpenGL ES 2.0 code or pure native C++ code based on Android NDK. Alternatively, the code generator 114 may generate native OpenGL ES 2.0 C++ code for Linux or Windows platforms, or for other platforms.

Once the code is created, it is available to a replayer service 116. The replayer service 116 may be an Android Application Package (APK) on Android or an executable binary on Linux or Windows, for either an Intel platform or an ARM platform. Alternatively, the replayer service 116 may be implemented with a virtual machine that executes the code created by the code generator 114. The replayer service 116 is used to replay one or more commands frame-by-frame.

The command translator 112 and code generator 114 may be implemented as a single software object. In an example implementation, the command translator 112 and code generator 114 are implemented using a single Python module that translates WebGL commands into native OpenGL ES 2.0 C++ commands, and then wraps them into an Android project with the Make file. In this example implementation, the replayer service 116 may generate the Android native application for either an x86 or ARM platform for further debugging or performance analysis.

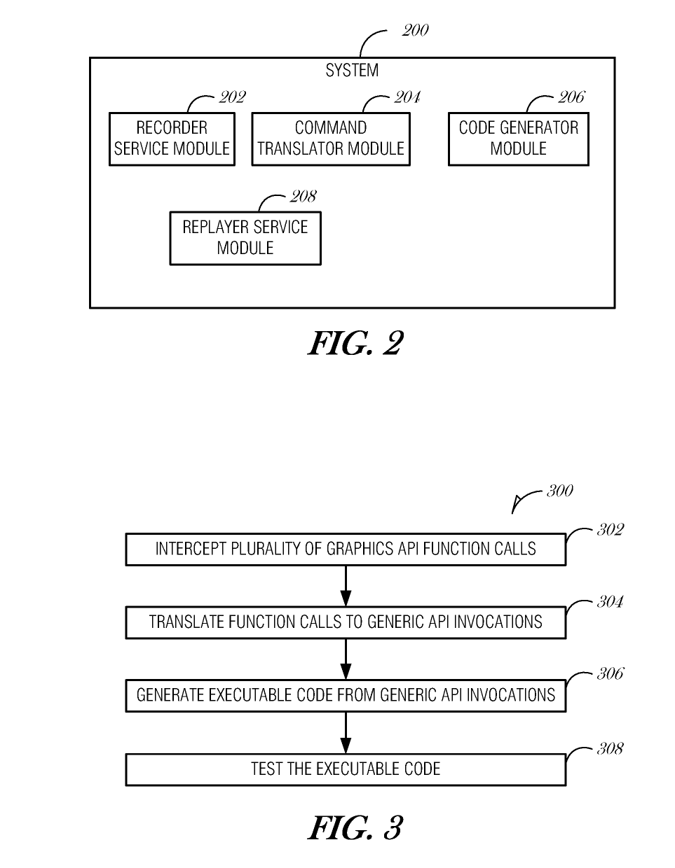

FIG. 2 is a block diagram illustrating a system 200 for analyzing WebGL applications, according to an embodiment. The system 200 includes a recorder service module 202, a command translator module 204, a code generator module 206, and a replayer service module 208. The recorder service module 202 may be configured to intercept a plurality of graphics application programming interface (API) function calls, each of the plurality of graphics API functions calls having an associated execution context. The command translator module 204 may be configured to translate the plurality of graphics API functions calls to a set of generic API invocations. The code generator module 206 may be configured to generate executable code from the set of generic API invocations. The replayer service module 208 may be configured to test the executable code.

In an embodiment, to intercept the plurality of graphics API function calls, the recorder service module 202 is to load a script in a browser page load operation, the script configured to record the plurality of graphics API function calls. In a further embodiment, to translate the plurality of graphics API functions calls to the set of generic API invocations, the command translator module 204 is to perform the translation while the browser is executing the plurality of API function calls.

In an embodiment, the recorder service module 202 is to buffer a plurality of graphics API function calls into a buffer and save the plurality of graphics API function calls to a log when the buffer is full.

In an embodiment, the plurality of graphics API function calls are a subset of WebGL commands. In an embodiment, the set of generic API invocations are a subset of OpenGL ES 2.0 commands.

In an embodiment, to generate executable code from the set of generic API invocations, the code generator module 206 is to generate an executable program for a target platform. In a further embodiment, the executable program is one of: a C program, a Java program, or a C++ program. In a further embodiment, the target platform is one of: a Windows® platform, an Android™ platform, or an Apple® platform.

In an embodiment, to test the executable code, the replayer service module 208 is to compile the executable code into an executable program and test the executable program. In an embodiment, to test the executable code, the replayer service module 208 is to instantiate a virtual machine and test the executable code in the virtual machine. Testing may include using a profiler to compare the execution of the code under test against a reference code set. Testing may be partially or fully automated to limit user interaction and intervention. The output from testing may include a report to highlight or identify sections of code that are operating at less than an optimal performance, causing bottlenecks, sections that have high processor (e.g., CPU or GPU) utilization, high memory utilization, or the like.

FIG. 3 is a flowchart illustrating a method 300 of analyzing WebGL applications, according to an embodiment. At block 302, on a computing platform, a plurality of graphics application programming interface (API) function calls are intercepted, each of the plurality of graphics API functions calls having an associated execution context. At block 304, the plurality of graphics API functions calls are translated to a set of generic API invocations. At block 306, executable code is generated from the set of generic API invocations and at block 308, the executable code is tested.

In an embodiment, intercepting the plurality of graphics API function calls comprises loading a script in a browser page load operation, the script configured to record the plurality of graphics API function calls. In a further embodiment, translating the plurality of graphics API functions calls to the set of generic API invocations occurs while the browser is executing the plurality of API function calls.

In an embodiment, the method 300 further comprises buffering a plurality of graphics API function calls into a buffer and saving the plurality of graphics API function calls to a log when the buffer is full.

In an embodiment, the plurality of graphics API function calls are a subset of WebGL commands. In an embodiment, the set of generic API invocations are a subset of OpenGL ES 2.0 commands.

In an embodiment, generating executable code from the set of generic API invocations comprises generating an executable program for a target platform. In an embodiment, the executable program is one of: a C program, a Java program, or a C++ program. In an embodiment, the target platform is one of: a Windows platform, an Android platform, or an Apple platform.

In an embodiment, testing the executable code comprise compiling the executable code into an executable program and testing the executable program. In an embodiment, testing the executable code comprises instantiating a virtual machine and testing the executable code in the virtual machine.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

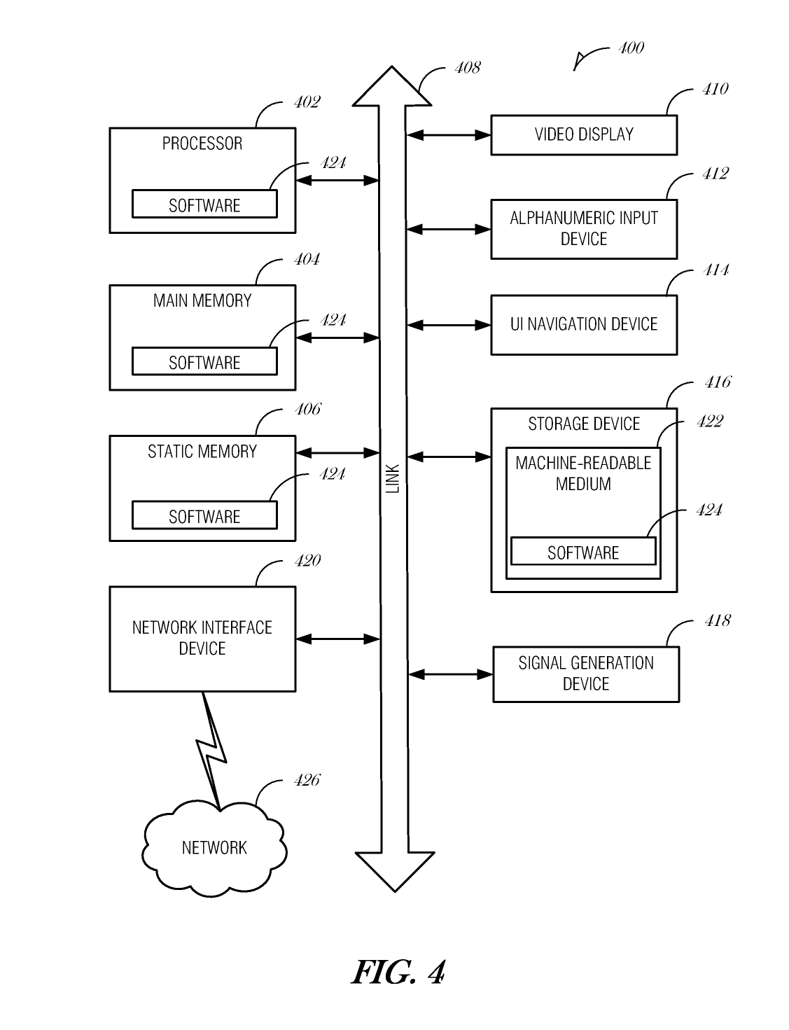

FIG. 4 is a block diagram illustrating a machine in the example form of a computer system 400, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 400 includes at least one processor 402 (e.g., a central processing unit (CPU), a graphics processing unit (GPU) or both, processor cores, compute nodes, etc.), a main memory 404 and a static memory 406, which communicate with each other via a link 408 (e.g., bus). The computer system 400 may further include a video display unit 410, an alphanumeric input device 412 (e.g., a keyboard), and a user interface (UI) navigation device 414 (e.g., a mouse). In one embodiment, the video display unit 410, input device 412 and UI navigation device 414 are incorporated into a touch screen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensor.

The storage device 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404, static memory 406, and/or within the processor 402 during execution thereof by the computer system 400, with the main memory 404, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 includes subject matter for analyzing WebGL applications (such as a device, apparatus, or machine) comprising: a recorder service module to intercept a plurality of graphics application programming interface (API) function calls, each of the plurality of graphics API functions calls having an associated execution context; a command translator module to translate the plurality of graphics API functions calls to a set of generic API invocations; a code generator module to generate executable code from the set of generic API invocations; and a replayer service module to test the executable code.

In Example 2, the subject matter of Example 1 may include, wherein to intercept the plurality of graphics API function calls, the recorder service module is to load a script in a browser page load operation, the script configured to record the plurality of graphics API function calls.

In Example 3, the subject matter of any one of Examples 1 to 2 may include, wherein to translate the plurality of graphics API functions calls to the set of generic API invocations, the command translator module is to perform the translation while the browser is executing the plurality of API function calls.

In Example 4, the subject matter of any one of Examples 1 to 3 may include, wherein the recorder service module is to: buffer a plurality of graphics API function calls into a buffer; and save the plurality of graphics API function calls to a log when the buffer is full.

In Example 5, the subject matter of any one of Examples 1 to 4 may include, wherein the plurality of graphics API function calls are a subset of WebGL commands.

In Example 6, the subject matter of any one of Examples 1 to 5 may include, wherein the set of generic API invocations are a subset of OpenGL ES 2.0 commands.

In Example 7, the subject matter of any one of Examples 1 to 6 may include, wherein to generate executable code from the set of generic API invocations, the code generator module is to generate an executable program for a target platform.

In Example 8, the subject matter of any one of Examples 1 to 7 may include, wherein the executable program is one of: a C program, a Java program, or a C++ program.

In Example 9, the subject matter of any one of Examples 1 to 8 may include, wherein the target platform is one of: a Windows platform, an Android platform, or an Apple platform.

In Example 10, the subject matter of any one of Examples 1 to 9 may include, wherein to test the executable code, the replayer service module is to: compile the executable code into an executable program; and test the executable program.

In Example 11, the subject matter of any one of Examples 1 to 10 may include, wherein to test the executable code, the replayer service module is to: instantiate a virtual machine; and test the executable code in the virtual machine.

Example 12 includes subject matter for analyzing WebGL applications (such as a method, means for performing acts, machine readable medium including instructions that when performed by a machine cause the machine to performs acts, or an apparatus to perform) comprising: intercepting, on a computing platform, a plurality of graphics application programming interface (API) function calls, each of the plurality of graphics API functions calls having an associated execution context; translating the plurality of graphics API functions calls to a set of generic API invocations; generating executable code from the set of generic API invocations; and testing the executable code.

In Example 13, the subject matter of Example 12 may include, wherein the intercepting the plurality of graphics API function calls comprises loading a script in a browser page load operation, the script configured to record the plurality of graphics API function calls.

In Example 14, the subject matter of any one of Examples 12 to 13 may include, wherein translating the plurality of graphics API functions calls to the set of generic API invocations occurs while the browser is executing the plurality of API function calls.

In Example 15, the subject matter of any one of Examples 12 to 14 may include, wherein the method further comprises: buffering a plurality of graphics API function calls into a buffer; and saving the plurality of graphics API function calls to a log when the buffer is full.

In Example 16, the subject matter of any one of Examples 12 to 15 may include, wherein the plurality of graphics API function calls are a subset of WebGL commands.

In Example 17, the subject matter of any one of Examples 12 to 16 may include, wherein the set of generic API invocations are a subset of OpenGL ES 2.0 commands.

In Example 18, the subject matter of any one of Examples 12 to 17 may include, wherein generating executable code from the set of generic API invocations comprises generating an executable program for a target platform.

In Example 19, the subject matter of any one of Examples 12 to 18 may include, wherein the executable program is one of: a C program, a Java program, or a C++ program.

In Example 20, the subject matter of any one of Examples 12 to 19 may include, wherein the target platform is one of: a Windows platform, an Android platform, or an Apple platform.

In Example 21, the subject matter of any one of Examples 12 to 20 may include, wherein testing the executable code comprises: compiling the executable code into an executable program; and testing the executable program.

In Example 22, the subject matter of any one of Examples 12 to 21 may include, wherein testing the executable code comprises: instantiating a virtual machine; and testing the executable code in the virtual machine.

Example 23 includes at least one machine-readable medium including instructions, which when executed by a machine, cause the machine to perform operations of any of the Examples 12-22.

Example 24 includes an apparatus comprising means for performing any of the Examples 12-22.

Example 25 includes subject matter for analyzing WebGL applications (such as a device, apparatus, or machine) comprising: means for intercepting, on a computing platform, a plurality of graphics application programming interface (API) function calls, each of the plurality of graphics API functions calls having an associated execution context; means for translating the plurality of graphics API functions calls to a set of generic API invocations; means for generating executable code from the set of generic API invocations; and means for testing the executable code.

In Example 26, the subject matter of Example 25 may include, wherein the means for intercepting the plurality of graphics API function calls comprise means for loading a script in a browser page load operation, the script configured to record the plurality of graphics API function calls.

In Example 27, the subject matter of any one of Examples 25 to 26 may include, wherein the means for translating the plurality of graphics API functions calls to the set of generic API invocations are implemented while the browser is executing the plurality of API function calls.

In Example 28, the subject matter of any one of Examples 25 to 27 may include, wherein the apparatus further comprises: means for buffering a plurality of graphics API function calls into a buffer; and means for saving the plurality of graphics API function calls to a log when the buffer is full.

In Example 29, the subject matter of any one of Examples 25 to 28 may include, wherein the plurality of graphics API function calls are a subset of WebGL commands.

In Example 30, the subject matter of any one of Examples 25 to 29 may include, wherein the set of generic API invocations are a subset of OpenGL ES 2.0 commands.

In Example 31, the subject matter of any one of Examples 25 to 30 may include, wherein the means for generating executable code from the set of generic API invocations comprise means for generating an executable program for a target platform.

In Example 32, the subject matter of any one of Examples 25 to 31 may include, wherein the executable program is one of: a C program, a Java program, or a C++ program.

In Example 33, the subject matter of any one of Examples 25 to 32 may include, wherein the target platform is one of: a Windows platform, an Android platform, or an Apple platform.

In Example 34, the subject matter of any one of Examples 25 to 33 may include, wherein the means for testing the executable code comprises: means for compiling the executable code into an executable program; and means for testing the executable program.

In Example 35, the subject matter of any one of Examples 25 to 34 may include, wherein the means for testing the executable code comprises: means for instantiating a virtual machine; and means for testing the executable code in the virtual machine.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-24. (canceled)

25. A system for analyzing WebGL applications, the system comprising:
a recorder service module to intercept a plurality of graphics application programming interface (API) function calls, each of the plurality of graphics API functions calls having an associated execution context;
a command translator module to translate the plurality of graphics API functions calls to a set of generic API invocations;
a code generator module to generate executable code from the set of generic API invocations; and
a replayer service module to test the executable code.

26. The system of claim 25, wherein to intercept the plurality of graphics API function calls, the recorder service module is to load a script in a browser page load operation, the script configured to record the plurality of graphics API function calls.

27. The system of claim 26, wherein to translate the plurality of graphics API functions calls to the set of generic API invocations, the command translator module is to perform the translation while the browser is executing the plurality of API function calls.

28. The system of claim 25, wherein the recorder service module is to:
buffer a plurality of graphics API function calls into a buffer; and
save the plurality of graphics API function calls to a log when the buffer is full.

29. The system of claim 25, wherein the plurality of graphics API function calls are a subset of WebGL commands.

30. The system of claim 25, wherein the set of generic API invocations are a subset of OpenGL ES 2.0 commands.

31. The system of claim 25, wherein to generate executable code from the set of generic API invocations, the code generator module is to generate an executable program for a target platform.

32. The system of claim 25, wherein to test the executable code, the replayer service module is to:
compile the executable code into an executable program; and
test the executable program.

33. The system of claim 25, wherein to test the executable code, the replayer service module is to:
instantiate a virtual machine; and
test the executable code in the virtual machine.

34. A method of analyzing WebGL applications, the method comprising:
intercepting, on a computing platform, a plurality of graphics application programming interface (API) function calls, each of the plurality of graphics API functions calls having an associated execution context:
translating the plurality of graphics API functions calls to a set of generic API invocations;
generating executable code from the set of generic API invocations; and
testing the executable code.

35. The method of claim 34, wherein the intercepting the plurality of graphics API function calls comprises loading a script in a browser page load operation, the script configured to record the plurality of graphics API function calls.

36. The method of claim 35, wherein translating the plurality of graphics API functions calls to the set of generic API invocations occurs while the browser is executing the plurality of API function calls.

37. The method of claim 34, wherein the method further comprises:
buffering a plurality of graphics API function calls into a buffer; and
saving the plurality of graphics API function calls to a log when the buffer is full.

38. The method of claim 34, wherein the plurality of graphics API function calls are a subset of WebGL commands.

39. The method of claim 34, wherein the set of generic API invocations are a subset of OpenGL ES 2.0 commands.

40. The method of claim 34, wherein generating executable code from the set of generic API invocations comprises generating an executable program for a target platform.

41. At least one machine-readable medium including instructions, which when executed by a machine, cause the machine to:
intercept a plurality of graphics application programming interface (API) function calls, each of the plurality of graphics API functions calls having an associated execution context:
translate the plurality of graphics API functions calls to a set of generic API invocations:
generate executable code from the set of generic API invocations; and
test the executable code.

42. The at least one machine-readable medium of claim 41, wherein the instructions to intercept the plurality of graphics API function calls includes instructions to load a script in a browser page load operation, the script configured to record the plurality of graphics API function calls.

43. The at least one machine-readable medium of claim 42, wherein the instructions to translate the plurality of graphics API functions calls to the set of generic API invocations are performed while the browser is executing the plurality of API function calls.

44. The at least one machine-readable medium of claim 41, including instructions to:
buffer a plurality of graphics API function calls into a buffer; and
save the plurality of graphics API function calls to a log when the buffer is full.
